(19) United States
(12) Patent Application Publication
(10) Pub. No.: US 2018/0327240 A1
(43) Pub. Date: Nov. 15, 2018

(54) A SELF-PROPELLED AERIAL PLATFORM

(71) Applicant: MAGNI TELESCOPIC HANDLERS S.R.L., Castelfranco Emilia (IT)

(72) Inventor: Riccardo MAGNI, Modena (IT)

(21) Appl. No.: 15/773,929

(22) PCT Filed: Nov. 15, 2016
(86) PCT No.: PCT/IB2016/001625

§ 371 Date: May 4, 2018

(30) Foreign Application Priority Data
Nov. 25, 2015 (IT) 102015000076797

(51) Int. Cl. B66F 11/04; B66F 9/075

(52) U.S. Cl. CPC B66F 11/046; B66F 9/07572

(57) ABSTRACT

A self-propelled aerial platform of the type including a work platform, provided at the end of an operating arm which is constrained to and supported by a base or turret. The base or turret is coupled, by means of a rotatable coupling around a vertical axis, on a mobile wheeled chassis or truck. At least one motor means, pumps and tanks of fluids are supported onto the mobile wheeled chassis or truck and are arranged beneath the rotatable coupling. Hydraulic and electrical couplings, which cooperate with rotatable coupling, are adapted to establish hydraulic and electrical connections between the motor means, pumps, tanks and the actuator means provided on the base or turret, the operating arm constrained thereto and supported thereby and the aerial work platform.

The object of the present invention is a self-propelled aerial platform of the type including a work platform provided at the free end of an operating arm, by means of which it can be moved, upon command, in the space, not only transferred and handled to be moved from one working place to another. There are known apparatuses suitable for this purpose, which however usually present a structure, often mounted on self-propelled operating machines, in which various members are mostly distributed in an operative part, comprising a telescopic and/or articulated arm, engines and other members grouped together and mounted to a base or turret, which is hinged on a usually vertical axis, on a truck or vehicle that moves on wheels.

In the specific application of the aerial platforms, such a conformation causes significant drawbacks mainly in connection with the relation between the weight of the apparatus and its stability during operation.

It is the object of the present invention to obviate the drawbacks and disadvantages of the prior art by providing a self-propelled aerial platform, comprising a work platform, provided at the end of an operating arm, which is constrained to and supported by a base or turret in turn coupled, by means of a rotatable coupling, to a mobile wheeled chassis or truck, which can support motor means, pumps and tanks of fluids, which are positioned beneath the rotatable coupling.

Besides the reduction of the height of the center of mass of the platform, the invention proposes a considerable improvement of the dynamic stability. These objects are obtained by the present invention, as described and claimed hereinafter.

The characteristics of the present invention will become more evident from the following description of one embodiment illustrated by way of not limiting example with the help of the enclosed figures, in which:

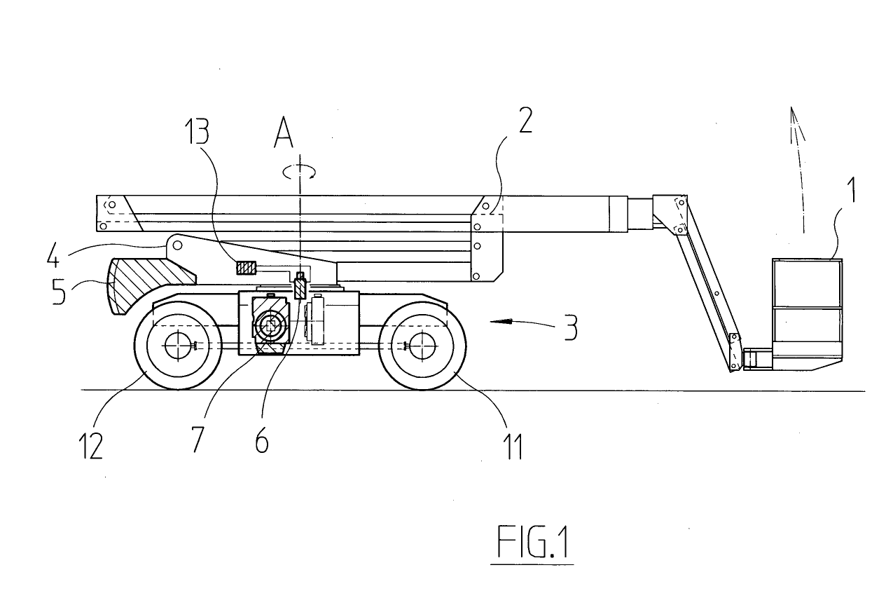

FIG. 1 is a schematic side, vertical, elevation view, partially in section of the invention;

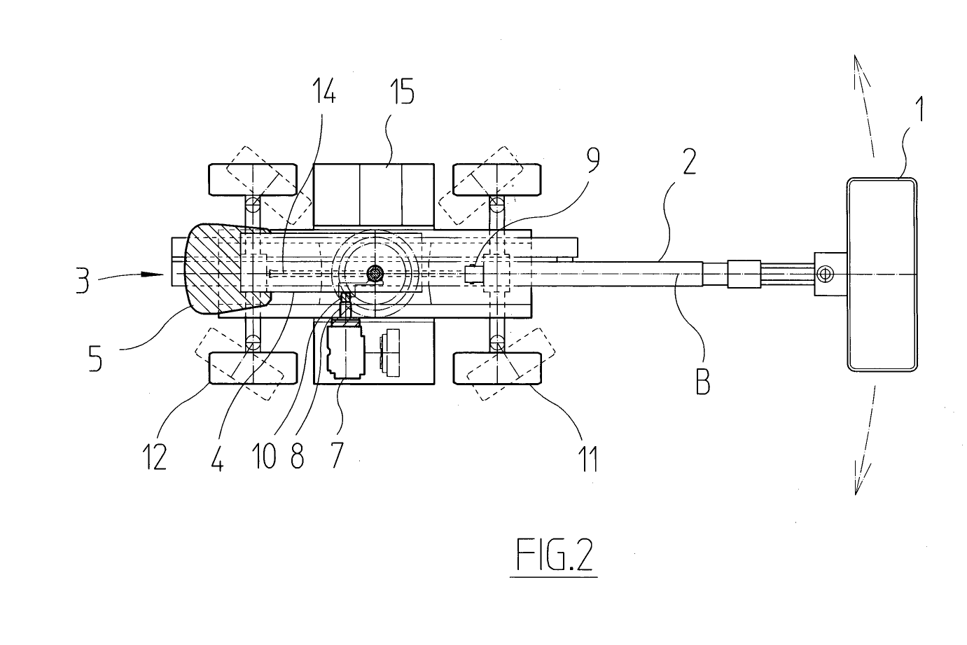

FIG. 2 is a schematic, plan, top view of FIG. 1.

With reference to the enclosed figures, the reference numeral 1 indicates an aerial work platform as a whole, provided at the end of an operating arm 2, which is constrained to and supported by a mobile wheeled chassis or truck 3 and can be operated to perform, upon command, rotations on a vertical axis A. For this purpose, the operating arm 2 is supported by a base or turret 4 which is coupled to the mobile wheeled chassis or truck 3 by means of a coupling rotatable around the vertical axis A, formed by a “fifth wheel”.

The whole forms a self-propelled aerial platform which can be typically used for transferring and lifting operators.

The base or turret 4 of the operating arm 2 is provided with a counterweight 5, placed in a position diametrically opposite to the aerial work platform 1. The counterweight 5 acts as a ballast.

The apparatus is provided with a motor, pumps and tanks of fluids, which are characterized by being supported onto the mobile wheeled chassis or truck 3 beneath the rotatable coupling between the base or turret 4 and the movable wheeled chassis or truck 3.

Hydraulic and electrical couplings 6 are provided, which cooperate with the rotatable coupling, to establish hydraulic and electrical connections between the motor means, pumps, tanks and the actuator means provided on the base or turret 4, the operating arm 2 being constrained thereto and supported thereby, and the aerial work platform 1.

In particular, it comprises a motor means 7, arranged in a median position, which has a rotation axis transverse to the longitudinal axis B of the mobile wheeled chassis or truck 3.

The motor means 7 operates a first hydraulic pump 8 for controlling the movements of the self-propelled platform and a second hydraulic pump 10 adapted to supply the driving means for moving the work platform.

In this case, the first hydraulic pump 8 is a hydrostatic pump and is situated in axis with the second hydraulic pump 10.

The first hydraulic pump 8 controls a hydraulic transmission 9, which is provided to operate the front wheels 11 of the mobile wheeled chassis or truck 3.

The illustrated embodiment provides also a mechanical transmission 14, adapted to transmit motion also to the rear wheels 12 of the mobile wheeled chassis or truck 3.

In particular, the hydraulic transmission 9 is composed by a hydrostatic motor.

All the hydraulic actuations are controlled by a hydraulic distributor 13.

Motors and pumps are situated on one side of the mobile wheeled chassis or truck 3 between a front wheel and the corresponding rear wheel so as to remain within the outline of the vehicle.

The tanks 15 are placed at the opposite side, between the corresponding front wheel and rear wheel, likewise in a way to remain within the outline of the vehicle.

The layout, distribution and support of the means like motor, pumps, tanks and other additional members, not pointed out within the outline, at least in height, of the mobile wheeled chassis or truck 3 and in particular, beneath the rotatable coupling between the base or turret 4 and the mobile wheeled chassis or truck 3 allow to obtain considerable advantages in comparison with the prior art, deriving from the low barycentre and lowering of the ballast, which in this case, is the counterweight 5.

Actually, positioning all the cited means and parts beneath the rotatable coupling, formed by a “fifth wheel”, by means of which the base or turret 4 can rotate with respect to the underlying movable wheeled chassis or truck 3, allows to obtain and position the ballast, formed by the counterweight 5 in such a manner that it is, at least partially, the outermost one, below the plane of the rotatable coupling. For this purpose the counterweight is suitably shaped.

Moreover, a better ergonomic use is obtained, due to an easier access to the various means and mechanical parts that are situated in positions which can be reached without difficulty. This allows an easy maintenance of the platform and of its various components.

1. A self-propelled aerial platform including a work platform provided at the end of an operating arm which is supported by a base or turret which is in turn joined to a mobile wheeled chassis or to a truck with the possibility to rotate with respect thereto, characterized in that the base or turret of said operating arm is coupled to said mobile chassis with a coupling rotatable about a vertical axis, it being provided that at least one motor means, pumps and tanks of fluids and other means are supported onto said mobile wheeled chassis or truck beneath said rotatable coupling, hydraulic and electrical couplings being also provided, which cooperate with said rotatable coupling to establish hydraulic and electrical connections between said at least a motor means, pumps and tanks and actuator means provided on the base or turret, the operating arm constrained thereto and supported thereby and the aerial work platform.

2. A self-propelled aerial platform according to claim 1 characterized in that it comprises a motor means, placed in a median position, which has a rotation axis transverse to the longitudinal axis of the mobile wheeled chassis or truck.

3. A self-propelled aerial platform according to claim 2 characterized in that said motor means drives a hydraulic pump for controlling the movements of the platform and a hydraulic pump adapted to feed the driving means for moving the working platform.

4. A self-propelled aerial platform according to claim 3 characterized in that said hydraulic pump is a hydrostatic pump.

5. A self-propelled aerial platform according to claim 3 characterized in that said mobile wheeled chassis or truck is operated to move by means of at least one hydraulic transmission.

6. A self-propelled aerial platform according to claim 5 characterized in that said at least one hydraulic transmission is a hydrostatic motor.

7. A self-propelled aerial platform according to claim 1 characterized in that a counterweight is fastened to the base or turret of said operating arm and is shaped and positioned so as to be, at least in part, beneath the plane of the rotatable coupling of said base or turret for connection to said mobile wheeled chassis or truck.
